(19) United States
(12) Patent Application Publication
(10) Pub. No.: US 2004/0156946 A1
(43) Pub. Date: Aug. 12, 2004

(54) Clamping unit

(76) Inventor: Jorg Dantlgraber, Lohr (DE)

Correspondence Address: Oliff & Berridge, PO Box 19928, Alexandria, VA, 22320, US

(21) Appl. No.: 10/477,281

(22) PCT Filed: Dec. 21, 2001
(86) PCT No.: PCT/DE01/04839

(30) Foreign Application Priority Data
May 11, 2001 (DE) 101 22 857.0

(51) Int. Cl. B29C 45/66

(52) U.S. Cl. 425/589; 425/450.1; 425/451.7

(57) ABSTRACT

What is disclosed is a clamping unit for an electrically operable injection molding machine having a drivable spindle whereby a mold backing plate may be moved in the closing direction. On the spindle a nut is guided, the axial movement of which may be transmitted to a mold backing plate. The axial or rotational movement of the nut acts on tilting members capable of being taken into clamping positions wherein the clamping forces acting on the mold backing plate may directly be introduced into the spindle or into a frame of the injection molding machine via the tilting members so as to alleviate the load on the spindle drive.

The invention relates to a clamping unit for an injection molding machine in accordance with the preamble of claim 1.

The like clamping units perform the closing and opening movements of the mold halves. In addition, it must be ensured by the clamping unit that the locking pressure required for the injection process will be sufficient to prevent the molding halves from being pushed apart by the plastified molding material flowing in under high pressure. In positive-engagement systems, for example toggle lever or spreader lever systems, locking together of the molding halves is achieved with the aid of self-locking mechanical components. In frictional systems, the locking pressure is applied via hydraulic operating cylinders or the like.

Concurrently with progressing automation, it has in recent years been a concern to replace the hydraulic drive mechanisms for injection molding machines with electrical drive mechanisms, as their control is mastered more easily. The electrical drive mechanism has to be designed such as to be capable, on the one hand, of rapidly closing the mold in a rapid motion, and on the other hand provides the required locking force during the injection process. From www.battenfeld.com an electrically driven clamping unit is known, wherein the movable backing plate is displaceable with the aid of an electrically driven spindle. This known solution is, however, used only with very low locking forces up to approx. 50 kN and a shot of 1.1 cm³ at the most.

The invention is based on the object of furnishing an electrically operated clamping unit which may be used even with high clamping forces.

This object is attained by the features of claim 1.

In accordance with the invention, the clamping unit comprises a spindle whereby the movable mold backing plate is displaceable for closing the mold. On the spindle a nut operatively connected with the mold backing plate is guided, on which nut at least one tilting member capable of being taken into a clamping position during closing of the mold is directly or indirectly supported, so that a force acting in the closing direction may be applied to the mold backing plate by the clamping members supported on the spindle or on a frame of the clamping unit, the clamping unit being reliably and frictionally locked in the clamping position of the tilting member. Here it is particularly preferred if a multiplicity of tilting members are arranged at a distance from the spindle axis, so that uniform application of the locking force is ensured. By the clamping action of the tilting members the load on the spindle drive mechanism is alleviated, thereby avoiding premature wear.

In an advantageous variant of the invention, the nut for closing the mold is initially displaced across the spindle in the axial direction. During the closing movement of the mold, or as a result of the action of an electromagnet, the nut is then immobilized relative to the spindle by means of a clamping nut, and owing to the resulting rotation of the nut, the tilting members are taken into their clamping positions.

In a preferred embodiment of the invention, the tilting members are supported on the mold backing plate on the one hand and on an end face of the adjacent nut on the other hand.

Joint rotation of the nut while the tilting members are disengaged may be prevented by rotation preventing means which do, however, allow the above described rotation of the nut in the clamping position of the tilting members. Such rotation preventing means may, e.g., be formed by pre-stressed springs, where the spring bias/spring rate is selected such that the nut is retained relative to the spindle during a rapid motion (closing movement of the mold), while the force of the spring is overcome by the torque applied to the spindle when the nut is immobilized relative to the spindle.

The clamping nut for immobilization of the nut relative to the spindle may be designed to be integral with the nut or a separate component.

The clamping nut may be biased into its clamping position with the aid of a clamping sleeve guided on the spindle, with a relative rotation between the clamping sleeve and the nut acting on the mold backing plate being utilized for biasing the clamping nut radially inwards against the spindle.

Transmission of these clamping forces may be performed by tilting members having a design similar to that of the tilting members used for clamping, and supported on the one hand on the clamping sleeve and on the other hand on the clamping nut, and which are taken by the relative rotation into an extended position wherein the clamping sleeve is clamped against the spindle.

In this solution, advantageously two rotation preventing means are employed, wherein the one rotation preventing means prevents a relative rotation of mold backing plate and nut during a rapid motion, while the second rotation preventing means maintains the relative positions of clamping sleeve and nut during a rapid motion—however, both rotation preventing means allow a relative rotation of the named components during locking.

In order to alleviate load on the spindle drive, the spindle is designed with an axial bearing so that the clamping forces of the tilting members are introduced into the frame of the clamping unit via the axial bearing.

In another embodiment of the invention, the clamping sleeve together with a clamping bush is guided on the nut driven by the spindle, and biased against one respective stop each. The mold backing plate is connected both with the clamping sleeve and with the nut by a toggle lever, so that during a rapid motion the axial displacement of the nut is transmitted to the mold backing plate via the clamping sleeve and the toggle lever. During locking, i.e. during application of a locking force, the toggle lever is taken into its extended position, and the clamping sleeve and the clamping bush are displaced relative to the nut. This relative displacement is utilized in order to take several tilting members, which are supported on the clamping sleeve and on the clamping bush, into a clamping position wherein the clamping sleeve and the clamping bush are supported on a frame of the clamping unit via the tilting members. In other words, while the clamping unit is locked, the clamping forces are introduced into the frame via the toggle lever, the clamping sleeve and the clamping bush as well as the tilting members, so that the load on the spindle drive is alleviated.

Further advantageous developments of the invention are subject matters of the further subclaims.

Preferred embodiments of the invention are hereinbelow explained in more detail by referring to schematic drawings, wherein:

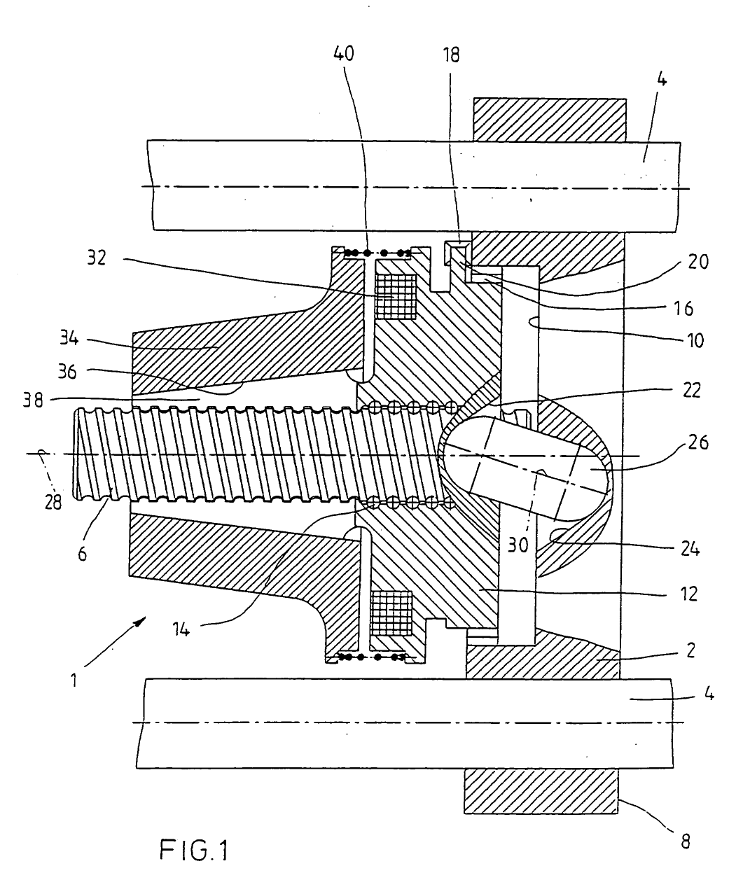

FIG. 1 is a sectional view of a first embodiment of a clamping unit having a clamping sleeve separate from a nut;

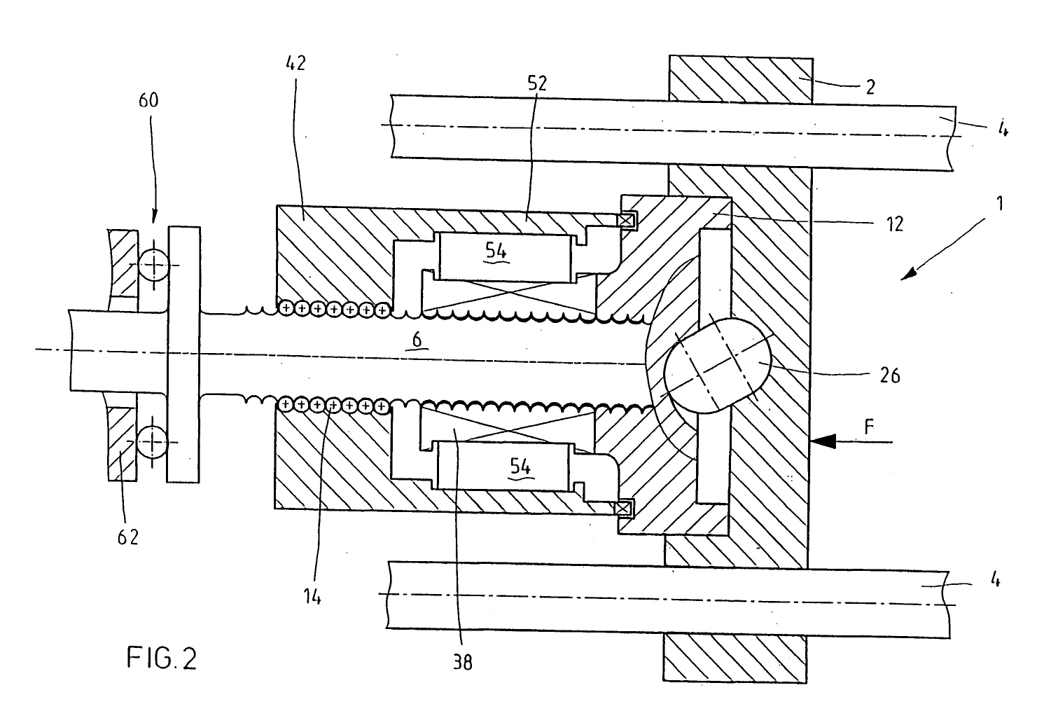

FIG. 2 is another embodiment of a clamping unit, wherein the clamping sleeve is formed integral with the nut;

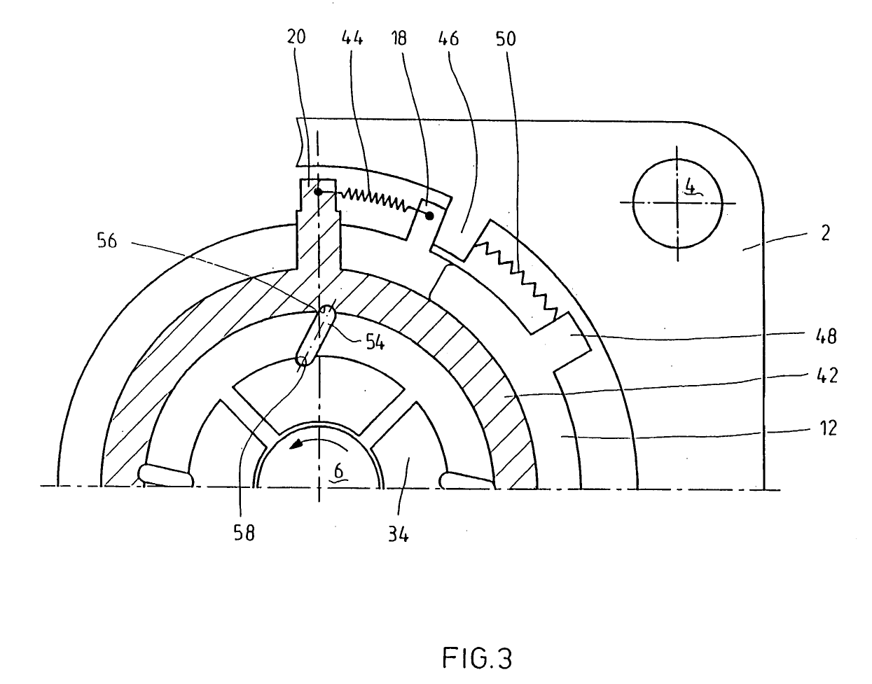

FIG. 3 is an elevational view of the clamping unit of FIG. 1; and

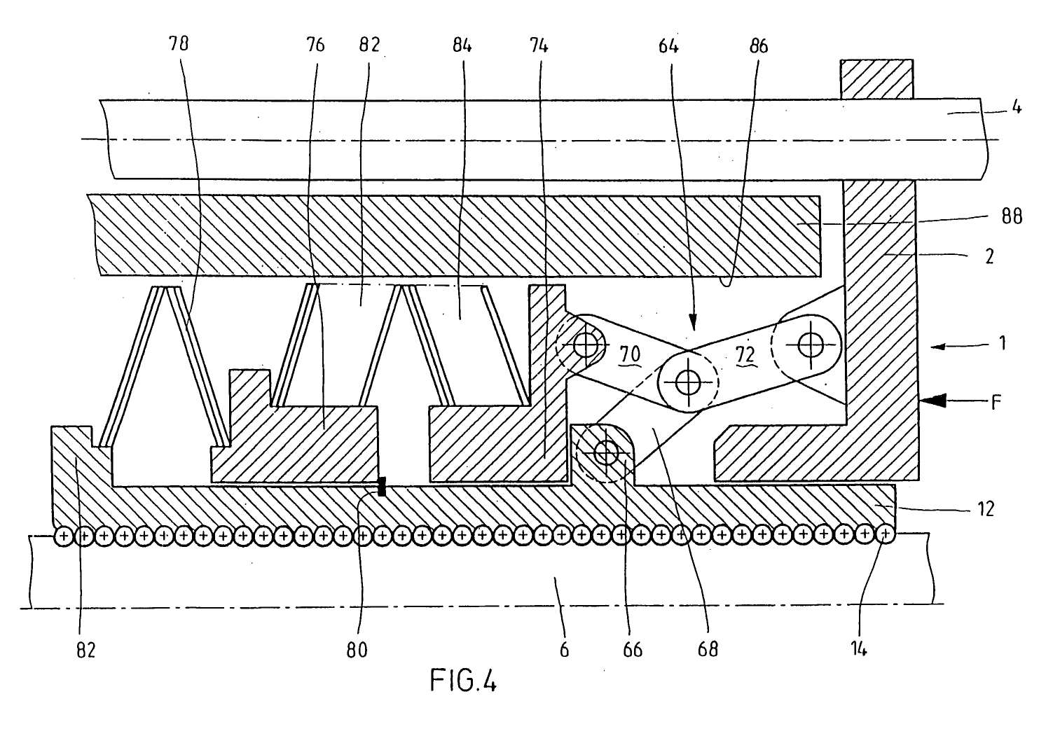

FIG. 4 is a sectional view of a third embodiment of a clamping unit according to the invention including a toggle lever.

FIG. 1 shows in highly simplified representation a sectional view of an electrically operated clamping unit 1 of an injection molding machine. It comprises a stationary mold backing plate (not represented) and a movable mold backing plate 2, to which the injection mold may be clamped. The movable mold backing plate 2 is guided on four tie-bars 4, only two of which are visible in the representation according to FIG. 1. These tie-bars 4 are—optionally with a bias—mounted in the bed of the injection molding machine.

The closing movement of movable mold backing plate 2 takes place with the aid of a spindle 6 rotatably mounted in clamping unit 1 and adapted to be driven by a drive mechanism (not represented), such as, e.g., a servomotor as used in molding machines. On the rear face of mold backing plate 2 that is removed from a mold clamping face 8, a recess 10 is formed into which the end face of a nut 12 plunges. The latter is in threaded engagement with spindle 6 via a ball or roller screw 14.

As is indicated in FIG. 1, nut 12 is radially guided inside recess 10. This radial guidance may, for instance, be performed by a needle bearing 16 encompassing the end portion of nut 12.

On mold backing plate 2 and on the external circumference of nut 12, rotation stops 18 and 20, respectively, are moreover secured which are held at a distance by a pre-stressed spring (not shown). Bias and spring rate of the spring are selected such that during a rapid motion, i.e. during rapid displacement of mold backing plate 2 shortly before contact between the two molding halves, nut 12 is not rotated relative to mold backing plate 2, so that the rotation of spindle 6 is converted into an axial displacement of nut 12.

In the end portion of nut 12 that plunges into recess 10 and in the adjacent base area of recess 10 pocket-shaped recesses 22, 24 are arranged in which a respective end portion each of a tilting member 26 is mounted. The axis 30 of this tilting member 26 in the represented position extends obliquely to spindle axis 28. Pockets 22, 24 and the corresponding end portions of tilting member 26 are made spherical, so that tilting member 26 is taken from the represented oblique inclination into a clamping position wherein the angle between spindle axis 28 and axis 30 of the tilting member is reduced.

In the embodiment represented in FIG. 1, several tilting members 26 are mounted in the range of the outer circumference of nut 12, i.e. tilting member 26 as represented in FIG. 1 is located at a radial distance from spindle 6.

On the end face of nut 12 that is removed from pocket-shaped recess 22, an approximately annular electromagnet 30 is disposed which may be energized via the control mechanism of the machine. By energizing this electromagnet 30 it is possible to take a clamping sleeve 34 from the spaced-apart position represented in FIG. 1 into a position where it contacts nut 12.

Clamping sleeve 34 has an inner cone 36 encompassing a correspondingly shaped circumferential surface of a clamping nut 38. Owing to the axial displacement of clamping sleeve 34, clamping nut 38 is taken into a position of engagement with spindle 6, so that the nut 12 is immobilized relative to spindle 6 through the intermediary of clamping nut 38 and clamping sleeve 34. Clamping nut 38 may be designed to be integral with nut 12 or as a separate component.

As is indicated in FIG. 1, nut 12 is held at a distance by a spring 40 while electromagnet 32 is not energized.

In order to displace movable mold backing plate 2 in a rapid motion, i.e. at a high moving velocity, until closely before the closed position of the mold, the drive mechanism of spindle 6 is actuated. Clamping nut 38 is not engaged, so that nut 12 does not rotate jointly with spindle 6 and is displaced in the closing direction. This closing movement is transmitted to mold backing plate 2 via the tilting members 26.

Once the mold has been closed, electromagnet 32 is energized, so that clamping sleeve 34 is moved to the right (FIG. 1) against the force of pressure spring 40, and clamping nut 38 is taken into its position of engagement, wherein nut 12 is immobilized relative to spindle 6. The torque applied by the latter and the resulting axial force are then transmitted directly to nut 12. Nut 12 subsequently rotates jointly with spindle 6, so that tilting members 26 are tilted in the direction of spindle axis 28 and thus mold backing plate 2 is frictionally locked by the clamping force applied by tilting members 26. This locking force is introduced into spindle 6 through the intermediary of tilting members 26 and the nut. The spindle may be supported by an axial bearing for improved axial support.

In FIGS. 2 and 3 another embodiment of a clamping unit 1 in accordance with the invention is represented, where locking takes places mechanically and not with the aid of an electromagnet 32 as in the above described embodiment.

Guidance of the movable mold backing plate 2 on tie-bars 4, the basic construction of nut 12 (apart from the fact that it does not have the form of a ball/roller bush) and of tilting members 26 conforms with those of the above described embodiments, so that further explanations in this respect may be omitted.

The nut 12 is—similar to the above described example—provided with a clamping nut 38 which may be deformed in a radially inward direction so as to bring about an immobilizing engagement with spindle 6. Clamping nut 38 is acted on through the intermediary of clamping sleeve 42 engaged with spindle 6 by means of a ball or roller screw.

In the embodiment represented in FIG. 2 respective rotation preventing means are provided between nut 12 and clamping sleeve 42 and between mold backing plate 2 and nut 12 so as to prevent clamping nut 42 and nut 12 from rotating jointly with spindle 6 in a rapid motion. FIG. 3 shows a possibility of executing such rotation preventing means.

Similar to the above described embodiment, in the variant represented in FIG. 3 the nut 12 and the clamping sleeve 42 are provided with one respective rotation stop 18 and 20 which are kept at a distance by a pre-stressed spring 44. Rotation stop 18 contacts a stop 46 of movable mold backing plate 2. The force of spring (44) is designed such that the friction and acceleration forces transmitted from spindle 6 to clamping nut 14 may be overcome. In other words, clamping nut 14 may only be rotated relative to nut 12 when the friction and acceleration forces introduced via spindle 6 are higher than the force applied by spring 44.

In accordance with FIG. 3, nut 12 has a radial projection 48 realized at a distance from rotation stop 18 and held at a distance from stop 46 by means of a pressure spring 50. Pressure spring 50 accordingly acts as a rotation stop preventing a rotation of nut 12 relative to mold backing plate 2 as long as the force of spring 50 is not overcome by the forces introduced via the spindle.

In accordance with the representation in FIG. 2, clamping sleeve 42 has an approximately cup-shaped construction, with annular jacket 52 encompassing clamping nut 38 at a distance. In the ring gap between annular jacket 52 and the external circumference of clamping nut 38, a plurality of clamping members 54 distributed over the circumference are disposed. In accordance with the elevational view in FIG. 3, the axis of clamping member 54 is inclined obliquely to the radial direction of clamping nut 42. Clamping members 54 are mounted in a reception 56 of clamping nut 42 on the one hand and in a reception 58 of the circle segments of clamping nut 38 on the other hand. The effect of these clamping members 54 is the same as that of tilting members 26, i.e., clamping members 54 are tilted in the axial direction relative to clamping nut 38 by a rotation of clamping sleeve 42, so that the spreader segments of clamping nut 38 are biased radially inwards and an engagement with spindle 6 preventing their relative rotation is thus established.

As may moreover be seen in FIG. 2, spindle 6 has an axial mount 60 whereby the axial forces upon locking are introduced into frame 62 of the injection molding machine.

In this variant, the rotating movement of spindle 6 is transmitted to clamping sleeve 42 via ball screw 14. During rapid movement, spring 44 acts as a rotary stop, so that clamping sleeve 42 does not perform a joint rotation. Correspondingly, nut 12 is also displaced in the axial direction jointly with clamping nut 38, wherein a rotation is prevented by pressure spring 50. Upon closing the mold, a force F counteracting an axial displacement of clamping sleeve 42 acts on mold backing plate 2. By this counterforce the tensioning force applied by spring 44 is overcome, so that clamping sleeve 42 is rotated relative to nut 12 which is held in its rotational position by pressure spring 50.

As a result of the relative rotation between clamping sleeve 42 and nut 12, clamping members 54 are pivoted in the above described manner, so that clamping nut 38 engages to immobilize nut 12 relative to spindle 6.

Owing to this connection of nut 12 with spindle 6 preventing their relative rotation, the force of the pressure spring 50 is overcome, so that nut 12 also jointly rotates with spindle 6. This relative rotation between nut 12 and mold backing plate 2 results—as in the embodiment described at the outset—in tilting members 26 being taken into their clamping position—the mold is locked, with the clamping forces being introduced into the frame of the injection molding machine via mold backing plate 2, pivoted clamping members 26, spindle 6, and axial bearing 60.

In FIG. 4 another embodiment is represented in which a toggle lever 64 is used for locking instead of tilting members 26.

In the embodiment represented in FIG. 4, as well, the movable mold backing plate 2 is guided on tie-bars 4 and may be displaced across spindle 6 in the opening and closing directions. The latter is engaged via ball screw 16 with a nut 12 which may be displaced when spindle 6 is driven in the axial direction.

On the external circumference of the spindle 12 a link 66 is formed, to which a toggle lever yoke 68 of toggle lever 66 is linked. The two levers 70, 72 of toggle lever 66 are linked to a clamping sleeve 74 guided on nut 12 in axial displacement, and to mold backing plate 2, respectively.

At a distance from the clamping sleeve 74 a clamping bush 76 is moreover guided on the external circumference of nut 12 and biased against an axial stop 80 through the intermediary of a biasing spring 78. Biasing spring 78 is supported on a ring collar 81 of nut 12.

In accordance with FIG. 4 there are supported on the external circumference of clamping bush 76 and of clamping sleeve 74 a plurality of clamping members 82 and 84, respectively, which extend from the external circumference of clamping sleeve, bush 74, 76 obliquely to the radial direction to a peripheral wall 86 of a frame member 88 supported on the bed of the injection molding machine. This frame member 88 may, for example, encompass the above described components of clamping unit 1 in the shape of a cylindrical jacket.

In accordance with FIG. 4, clamping members 82, 84 each have the form of a set of individual elements, wherein clamping members 84 are inclined to the left towards frame member 88, whereas clamping members 82 are inclined in the opposite direction.

When spindle 6 is driven, nut 12 is displaced to the right in order to close the mold. This axial displacement is transmitted via biasing spring 78, clamping bush 76, clamping members 82, 84, clamping sleeve 74 and toggle lever 66 to the movable mold backing plate 2, so that the latter is moved in the closing direction. Upon closing the mold, force F acts on mold backing plate 2, so that the latter is braked, and toggle lever yoke 68 is pivoted to the left in the representation according to FIG. 4. In the process, toggle lever 66 is moved in the direction of its extended position, and clamping sleeve 74 is moved to the left, so that it is raised from link 66 which acts as a stop.

At the same time, clamping bush 76 is biased by the force of biasing spring 78 against axial stop 80—in other words, clamping sleeve 74 and clamping bush 76 approach each other. Owing to this respective relative movement of clamping sleeve 74 and clamping bush 76 with regard to frame member 88, clamping members 82, 84 are pivoted from their oblique position in the radial direction, so that a frictional engagement between toggle lever 66 and frame 88 is created, and the axial forces acting on spindle 6 are reduced.

During the continued movement of nut 12, axial stop 80 moves away from the clamped clamping bush 76, and toggle lever yoke 68 is rotated further to the left in accordance with FIG. 4, and toggle lever 66 is taken into its extended position for clamping the clamping unit. In this extended position, the closing force acting on mold backing plate 2 is introduced into frame member 88 via toggle lever 66, clamping sleeve 74, clamping bush 76, clamping members 82, 84, so that the load on the ball screw between spindle 6 and nut 12 is alleviated.

All of the above described embodiments share the feature that a rotating or axial movement of nut 12 is utilized in order to take clamping members into their clamping positions, through which a frictional connection with the spindle or with a frame member is established, so as to thereby reduce the forces acting on the spindle drive and ensure reliable locking.

What is disclosed is a clamping unit for an electrically operable injection molding machine having a drivable spindle whereby a mold backing plate may be moved in the closing direction. On the spindle a nut is guided, the axial movement of which may be transmitted to a mold backing plate. The axial or rotational movement of the nut acts on tilting members capable of being taken into clamping positions wherein the clamping forces acting on the mold backing plate may directly be introduced into the spindle or into a frame of the injection molding machine via the tilting members so as to alleviate the load on the spindle drive.

### LIST OF REFERENCE NUMERALS

1 clamping unit 46 stop

2 movable mold backing plate 48 radial projection

4 tie-bar 50 pressure spring

6 spindle 52 annular jacket

8 clamping face 54 clamping member

10 recess 56 reception

12 nut 58 reception

14 ball screw 60 axial bearing

16 needle bearing 62 frame

18 rotation stop 64 toggle lever

20 rotation stop 66 link

22 pocket-type recess 68 toggle lever yoke

24 pocket-type recess 70 lever

26 tilting member 72 lever

28 spindle axis 74 clamping sleeve

30 axis 76 clamping bush

32 electromagnet 78 biasing spring

34 clamping sleeve 80 axial stop

36 inner cone 81 ring collar

38 clamping nut 82 clamping members

40 spring 84 clamping members

42 clamping sleeve 86 peripheral wall

44 spring 88 frame member

1. Clamping unit for an injection molding machine, comprising a movable mold backing plate (2) capable of being displaced with the aid of a spindle (6) for closing a mold, and comprising locking means whereby said mold is held in its closed position, characterized in that said locking means include a nut (12) which is engaged with said spindle (6) and on which at least one tilting member (26; 82, 84) is supported directly or indirectly, which tilting member is capable of being taken, through a closing movement of said nut (12), into a clamping position wherein said mold backing plate (2) is supported on said spindle (6) or on a frame of said clamping unit (1) through the intermediary of said tilting member (26; 82, 84).

2. Clamping unit according to claim 1, wherein a plurality of tilting members (26; 82, 84) are arranged at a distance from the axis of said spindle.

3. Clamping unit according to claim 1 or 2, wherein said nut (12) is capable of being immobilized against rotation relative to said spindle (6) by means of a clamping nut (38), wherein said tilting members (26) are supported on said nut (12) on the one hand, and on said mold backing plate (2) on the other hand.

4. Clamping unit according to claim 2, wherein said clamping nut (38) is capable of being taken into its clamping position with the aid of an electromagnet (32).

5. Clamping unit according to claim 3 or 4, comprising rotation preventing means (18, 20; 46, 48; 44, 50) whereby a rotation of said nut (12) is prevented in the disengaged condition of said clamping nut (38).

6. Clamping unit according to claim 3 and 5, wherein said clamping nut (38) is designed integral with said nut (12) and with the aid of a clamping sleeve (42) engaged with said spindle (6) is capable of being taken into its clamping position wherein said rotation preventing means (18, 20, 44) permit a relative rotation between nut (12) and clamping sleeve (38, 42).

7. Clamping unit according to claim 6, wherein clamping members (54) are arranged between clamping sleeve (42) and nut (12), which clamping members are capable of being taken into a clamping position acting on said clamping nut (38) in the clamping direction through relative rotation between nut (12) and clamping sleeve (42).

8. Clamping unit according to claim 4, 5, or 6, wherein on respective rotation preventing means is provided between mold backing plate (2) and nut (12) and between nut (12) and clamping sleeve (42).

9. Clamping unit according to any one of the preceding claims, wherein said spindle (6) is supported in the axial direction with the aid of an axial bearing (60).

10 Clamping unit according to claim 1, wherein a clamping sleeve (74) and a clamping bush (76) spaced apart therefrom are guided on said nut (12), said clamping sleeve (74) and said nut (12) being connected with said mold backing plate (2) through the intermediary of a toggle lever (64), and said tilting members (82, 84) extending between clamping bush (76) or clamping sleeve (74), respectively, and a frame member (88) of said clamping unit (1), respectively.

11. Clamping unit according to claim 10, wherein said clamping sleeve (74) and said clamping bush (76) are each biased against a nut-side stop (66, 80) whereby the advancing movement of said nut (12) is transmittable to said clamping sleeve (74) and said clamping bush (76), and the latter are in the extended position of said toggle lever (64) raised from said stops (66, 80) and, owing to the displacement relative to said frame member (88), said tilting members (82, 84) are capable of being taken into their clamping positions wherein said mold backing plate (2) is supported on said frame member (88) through the intermediary of said toggle lever (64), said clamping sleeve (74), said clamping bush (76) and said clamping members (82, 84).
